(19) United States
(12) Patent Application Publication
(10) Pub. No.: US 2024/0417607 A1
(43) Pub. Date: Dec. 19, 2024

(54) A MOISTURE RESISTANT TWO-COMPONENT ADHESIVE COMPOSITION

(71) Applicants: Dow Global Technologies LLC, Midland, MI (US); Dow Silicones Corporation, Midland, MI (US)

(72) Inventors: Yanbin Fan, Shanghai (CN); Yanxia Huang, Shanghai (CN); Yi Zhang, Shanghai (CN); Qihang Qiu, Shanghai (CN); Ping Zhang, Shanghai (CN)

(21) Appl. No.: 18/703,386

(22) PCT Filed: Nov. 26, 2021
(86) PCT No.: PCT/CN2021/133451

§ 371 Date: Apr. 22, 2024

(51) Int. Cl. C09J 175/06; C08G 18/38; C08G 18/42; C08G 18/79; C09J 11/04

(52) U.S. Cl. CPC C09J 175/06; C08G 18/3882; C08G 18/4288; C08G 18/791; C09J 11/04; C09J 2203/33; C09J 2301/208; C09J 2475/00

(57) ABSTRACT

A two-component adhesive composition comprising the reaction product of: a polyol component, comprising at least one hydrophobic polyol: and an isocyanate component, comprising polyphosphoric acid and the reaction product of (I) an isocyanate compound and (II) a dimer acid polyester polyol.

### FIELD OF THE INVENTION

The present disclosure relates to an adhesive composition, more particularly to a moisture resistant two-component adhesive composition.

### INTRODUCTION

Mass production of battery packs in an economic way has gained revolutionary development during the past years and leaped forward the adoption of electrical vehicles (EV) all over the world. Due to low cost, low volatility, high body strength and toughness, polyurethane adhesives have become popular solutions to battery pack assembly, where battery cells are bonded onto cooling plates by the polyurethane adhesives.

The bonding substrates for battery pack assembly mainly include Al alloys, PET films, polycarbonates etc., where Al alloy-Al alloy bonding is the most significant one. However, the effective bonding between Al alloys is difficult due to high surface energy and absence of organic chemical groups on the Al alloy surfaces. On the other hand, moisture resistance of the polyurethane components (including polyol and isocyanate parts) is another important industrial need. This is because both the polyol and isocyanate parts could easily absorb moistures. For the isocyanate parts, the absorbed moisture leads to reduction of NCO contents and formation of solid skins starting from the top of the components. As a result, the reduced NCO contents will cause incorrect feed ratios between the reaction groups and the thick skins usually block the storage tanks and/or dispensing tunnels, leading to product defects and production breaks, respectively. For the polyol parts, the absorbed moistures could bring significant bubbles to the cured adhesives after mixing and dispensing the polyol parts with isocyanate parts. Therefore, the more moisture-resistant, the better its industrial uses are.

It is difficult for current two-component polyurethane adhesives to meet these requirements simultaneously.

Accordingly, there is a need for a polyurethane adhesive with strong bonding strength on substrates, especially Al alloy-Al alloy interface, and inert to the moisture intake during the adhesive application.

### SUMMARY OF THE INVENTION

In a first aspect of the present disclosure, the present disclosure provides a two-component adhesive composition comprising the reaction product of:
A) a polyol component, comprising at least one hydrophobic polyol: and
B) an isocyanate component, comprising a polyphosphoric acid and the reaction product of (I) an isocyanate compound and (II) a dimer acid polyester polyol.

In a second aspect of the present disclosure, the present disclosure provides a multi-layer structure comprising
a first substrate:
a second substrate; and
an adhesive layer between the first substrate and the second substrate, wherein the adhesive layer is formed from the two-component adhesive composition described herein.

In a third aspect of the present disclosure, the present disclosure provides a method of forming a two-component adhesive composition comprising:
(i) providing a polyol component A), comprising at least one hydrophobic polyol:
(ii) providing an isocyanate component B), comprising a polyphosphoric acid and the reaction product of (I) an isocyanate compound and (II) a dimer acid polyester polyol; and
(iii) then reacting the isocyanate component B) with the polyol component A) to form the two-component adhesive composition described herein.

In a fourth aspect of the present disclosure, the present disclosure provides use of the two-component adhesive composition in a battery pack.

It is to be understood that both the foregoing general description and the following detailed description are exemplary and explanatory only and are not restrictive of the invention, as claimed.

### DETAILED DESCRIPTION OF THE INVENTION

Unless defined otherwise, all technical and scientific terms used herein have the same meaning as commonly understood by one of ordinary skill in the art to which the invention belongs. Also, all publications, patent applications, patents, and other references mentioned herein are incorporated by reference.

### Definitions

The numerical ranges disclosed herein include all values from, and including, the lower and upper value. For ranges containing explicit values (e.g., a range from 1, or 2, or 3 to 5, or 6, or 7), any subrange between any two explicit values is included (e.g., the range 1-7 above includes subranges 1 to 2:2 to 6; 5 to 7:3 to 7:5 to 6; etc.).

Unless stated to the contrary, implicit from the context, or customary in the art, all parts and percentages are based on weight and all test methods are current as of the filing date of this disclosure.

The term “composition” refers to a mixture of materials which comprise the composition, as well as reaction products and decomposition products formed from the materials of the composition.

The terms “comprising,” “including,” “having,” and their derivatives, are not intended to exclude the presence of any additional component, step or procedure, whether or not the same is specifically disclosed. To avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or” unless stated otherwise, refers to the listed members individually as well as in any combination. Use of the singular includes use of the plural and vice versa.

A “dicarboxylic acid” is a compound containing two carboxyl (—COOH) groups.

An “isocyanate” is a chemical that contains at least one isocyanate group in its structure. An isocyanate group is represented by the formula: —N═C═O. An isocyanate that contains more than one, or at least two, isocyanate groups is a “polyisocyanate”. An isocyanate that has two isocyanate groups is a di-isocyanate and an isocyanate that has three isocyanate groups is a tri-isocyanate, etc. An isocyanate may be aromatic or aliphatic.

A “polyol” is an organic compound containing multiple hydroxyl (—OH) groups. In other words, a polyol contains at least two hydroxyl groups. Nonlimiting examples suitable polyols include diols (which contain two hydroxyl groups), triols (which contain three hydroxyl groups), and multi-hydroxyl containing polyols.

A “polyether” is a compound containing two or more ether linkages in the same linear chain of atoms.

A “polyester” is a compound containing two or more ester linkages in the same linear chain of atoms.

A “polyester polyol” is a compound that is a polyester and a polyol.

A “polymer” is a polymeric compound prepared by polymerizing monomers, whether of the same or a different type. The generic term polymer thus embraces the term “homopolymer” (employed to refer to polymers prepared from only one type of monomer, with the understanding that trace amounts of impurities can be incorporated into the polymer structure), and the term “interpolymer” (which is used interchangeably with the term “copolymer”) includes bipolymers (employed to refer to polymers prepared from two different types of monomers), terpolymers (employed to refer to polymers prepared from three different types of monomers), and polymers prepared from more than three different types of monomers. Trace amounts of impurities, for example, catalyst residues, may be incorporated into and/or within the polymer. It also embraces all forms of copolymer, e.g., random, block, etc. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to as being based on “units” that are the polymerized form of a corresponding monomer.

### A. Polyol Component

The two-component adhesive composition comprises the reaction product of A) a polyol component and B) an isocyanate component. The polyol component A) comprises at least one hydrophobic polyol. The polyol component A) may optionally comprise at least one selected from a polyether polyol, a polyester polyol, a polyether ester polyol, a polycarbonate polyol, a polyurethane polyol or a combination thereof. The polyol component A) may optionally comprise a chain extender.

### Hydrophobic Polyol

A hydrophobic polyol refers to a hydrophobic polyol with at least two hydroxyl groups.

In an embodiment, the hydrophobic polyol is selected from a vegetable oil, a hydrophobic polyol derived from a vegetable oil, or a mixture thereof. The vegetable oil can be castor oil, soybean oil, and the like.

In an embodiment, the hydrophobic polyol is castor oil, a hydrophobic polyol derived from castor oil, soybean oil, a hydrophobic polyol derived from soybean oil or a mixture thereof.

The hydrophobic polyol derived from a vegetable oil refers to a hydrophobic polyol which is obtained by alkoxylation, esterification or polyurethane reaction of the vegetable oil to increase the molecular weight of the vegetable oil, wherein the hydrophobic polyol derived from a vegetable oil has two or more hydroxyl groups.

The hydrophobic polyol derived from a vegetable oil can be the polyurethane reaction product of a reaction mixture including (i) an isocyanate compound, (ii) a polyol, and (iii) a vegetable oil.

An “isocyanate compound” is a molecule that contains at least two isocyanate groups. The isocyanate compound may chemically bind to a polyol to form a prepolymer. Nonlimiting examples of suitable isocyanate compounds include aromatic isocyanates, aliphatic isocyanates, carbodiimide modified isocyanate compounds, and the combinations thereof.

An “aromatic isocyanate compound” is an isocyanate compound containing one or more aromatic rings. Nonlimiting examples of suitable aromatic isocyanate compounds include isomers of methylene diphenyl diisocyanate (MDI) such as 4, 4-MDI, 2, 4-MDI and 2, 2′-MDI; or modified MDI such as carbodiimide modified MDI or allophanate modified MDI; isomers of toluene-diisocyanate (TDI) such as 2, 4-TDI, 2, 6-TDI: isomers of naphthalene-diisocyanate (NDI) such as 1, 5-NDI; and combinations thereof.

An “aliphatic isocyanate compound” is an isocyanate compound that the isocyanate moiety (—NCO) is not directly connected to aromatic rings. Nonlimiting examples of suitable aliphatic isocyanate compounds include isomers of hexamethylene diisocyanate (HDI), isomers of isophorone diisocyanate (IPDI), isomers of xylene diisocyanate (XDI), other cycloaliphatic isocyanates such as methylene bis-cyclohexyl isocyanate (hydrogenated MDI) (HMDI) and cyclohexane diisocyanate, and combinations thereof.

In an embodiment, the isocyanate compound is selected from a mono-isocyanate compound, a di-isocyanate compound, a tri-isocyanate compound, and combinations thereof. In a further embodiment, the isocyanate compound is a di-isocyanate compound.

In an embodiment, the isocyanate compound is a multifunctional isocyanate compound with at least two isocyanate groups, or at least three isocyanate groups.

In an embodiment, the isocyanate compound is selected from MDI, TDI, HDI, and combinations thereof. In a further embodiment, the isocyanate compound is MDI.

In an embodiment, the isocyanate compound is selected from carbodiimide modified MDI, carbodiimide modified TDI, carbodiimide modified HDI, and combinations thereof. In a further embodiment, the isocyanate compound is carbodiimide modified MDI, such as ISONATE 143 L from The Dow Chemical Company.

The polyol for preparing the polyurethane reaction product of a reaction mixture including (i) an isocyanate compound, (ii) a polyol, and (iii) a vegetable oil can be a polyester polyol, a polyether polyol or the combination thereof, preferably, a polyether polyol. A “polyether polyol” is a compound that is a polyether and a polyol. Nonlimiting examples of suitable polyether polyols include polyaddition products of ethylene oxide, propylene oxide, tetrahydrofuran, butylene oxide, and the co-addition and grafted products thereof: the polyether polyols obtained by condensation of polyhydric alcohols: and combination thereof.

Nonlimiting examples of suitable polyether polyols include polypropylene glycol (PPG), polyethylene glycol (PEG), polybutylene glycol, polytetramethylene ether glycol (PTMEG), and combinations thereof. In an embodiment, the polyether polyol is polypropylene glycol (PPG).

Nonlimiting examples of suitable polyether polyols include VORANOL™ P400, VORANOL™ 1010 L, a PPG: and VORANOL™ CP450, a glycerin propoxylated polyether triol, each available from Dow.

In an embodiment, the polyether polyol has a molecular weight (Mw) from 50 g/mol, or 100 g/mol, or 400 g/mol, or 450 g/mol to 1,000 g/mol, or 1,500 g/mol, or 2,000 g/mol, or 4,000 g/mol, or 5,000 g/mol.

In an embodiment, the polyether polyol has a hydroxyl number from 30 mg KOH/g, or 50 mg KOH/g, or 75 mg KOH/g, or 100 mg KOH/g to 115 mg KOH/g, or 125 mg KOH/g, or 150 mg KOH/g, or 200 mg KOH/g, or 300 mg KOH/g, or 350 mg KOH/g, or 400 mg KOH/g, or 450 mg KOH/g, or 500 mg KOH/g.

In an embodiment, the polyether polyol has one or both of the following properties: (i) a molecular weight from 50 g/mol to 5,000 g/mol, or from 100 g/mol to 2,000 g/mol, or from 400 g/mol to 1,500 g/mol, or from 400 g/mol to 1,000 g/mol; and/or (ii) a hydroxyl number from 30 mg KOH/g to 500 mg KOH/g, or from 100 mg KOH/g to 400 mg KOH/g, or from 100 mg KOH/g to 150 mg KOH/g, or from 350 mg KOH/g to 400 mg KOH/g.

The polyol component A) comprises 20-60 wt %, preferably 25-50 wt %, more preferably 26-45 wt %, even more preferably 28-40 wt % of hydrophobic polyol, preferably castor oil and/or a hydrophobic polyol derived from castor oil, based on the total weight of the polyol component A).

The polyol component A) comprises 10-50 wt %, preferably 12-40 wt %, more preferably 15-25 wt %, even more preferably 15-20 wt % of a vegetable oil, preferably castor oil or soybean oil, based on the total weight of the polyol component A).

The polyol component A) comprises 1-30 wt %, preferably 2-25 wt %, more preferably 5-20 wt %, even more preferably 8-15 wt % of a hydrophobic polyol derived from a vegetable oil, preferably a polyurethane reaction product of a reaction mixture including (i) an isocyanate compound, (ii) a polyol, and (iii) a vegetable oil, based on the total weight of the polyol component A).

### Polyether Polyol

The polyol component A) may further comprise a polyether polyol. A “polyether polyol” is a compound that is a polyether and a polyol. Nonlimiting examples of suitable polyether polyols include polyaddition products of ethylene oxide, propylene oxide, tetrahydrofuran, butylene oxide, and the co-addition and grafted products thereof: the polyether polyols obtained by condensation of polyhydric alcohols, or mixtures thereof; and combination thereof.

Nonlimiting examples of suitable polyether polyols include polypropylene glycol (PPG), polyethylene glycol (PEG), polybutylene glycol, polytetramethylene ether glycol (PTMEG), and combinations thereof. In an embodiment, the polyether polyol is polypropylene glycol (PPG).

Nonlimiting examples of suitable polyether polyols include VORANOL™ 1010 L, a PPG: and VORANOL™ CP450, a glycerin propoxylated polyether triol, each available from Dow.

In an embodiment, the polyether polyol has a molecular weight from 50 g/mol, or 100 g/mol, or 400 g/mol, or 450 g/mol to 1,000 g/mol, or 1,500 g/mol, or 2,000 g/mol, or 4,000 g/mol, or 5,000 g/mol.

In an embodiment, the polyether polyol has a hydroxyl number from 30 mg KOH/g, or 50 mg KOH/g, or 75 mg KOH/g, or 100 mg KOH/g to 115 mg KOH/g, or 125 mg KOH/g, or 150 mg KOH/g, or 200 mg KOH/g, or 300 mg KOH/g, or 350 mg KOH/g, or 400 mg KOH/g, or 450 mg KOH/g, or 500 mg KOH/g.

In an embodiment, the polyether polyol has one or both of the following properties: (i) a molecular weight from 50 g/mol to 5,000 g/mol, or from 100 g/mol to 2,000 g/mol, or from 400 g/mol to 1,500 g/mol, or from 400 g/mol to 1,000 g/mol: and/or (ii) a hydroxyl number from 30 mg KOH/g to 500 mg KOH/g, or from 100 mg KOH/g to 400 mg KOH/g, or from 100 mg KOH/g to 150 mg KOH/g, or from 350 mg KOH/g to 400 mg KOH/g.

Preferably, the polyol component A) may comprise 1-20 wt %, preferably 1.5-15 wt %, more preferably 2-12 wt %, even more preferably 3-6 wt % of polyether polyol, preferably, glycerin propoxylated polyether triol, based on the total weight of the polyol component A).

### Polyester Polyol

Polyester polyols suitable for use include, but are not limited to, polycondensates of diols and also, optionally, polyols (e.g., triols, tetraols), and of dicarboxylic acids and also, optionally, polycarboxylic acids (e.g., tricarboxylic acids, tetracarboxylic acids) or hydroxycarboxylic acids or anhydrides or lactones.

Preferably, the polyol component A) may comprise 0-20 wt %, preferably 1-15 wt %, more preferably 2-12 wt %, even more preferably 3-6 wt % of polyester polyol based on the total weight of the polyol component A).

### Polyurethane Polyol

Polyurethane polyol could be synthesized using isocyanates as chain extenders whereas hydroxyl groups as end groups, which is familiar to engineers with polyurethane background. An example synthesis of a polyurethane polyol can be found in the Example Section.

Preferably, the polyol component A) may comprise 0-20 wt %, preferably 1-15 wt %, more preferably 2-12 wt %, even more preferably 3-6 wt % of polyurethane polyol based on the total weight of the polyol component A).

### Chain Extenders

The polyol component A) may optionally comprises chain extenders. Nonlimiting examples of suitable chain extenders include glycerin: trimethylol propane: diethylene glycol: propanediol: 2-methyl-1, 3-propanediol: 1,4-butanediol (BDO); and combinations thereof, preferably 1,4-butanediol (BDO).

The polyol component A) comprises 0-10 wt %, preferably 0.5-9 wt %, more preferably 1-8 wt %, even more preferably 2-6 wt %, or 2-3 wt % of chain extenders, preferably, 1,4-butanediol (BDO), based on the total weight of the polyol component A.

The polyol component A) can optionally comprise moisture scavengers, catalysts, flame retardants, rheology modifiers, fillers and the like.

Moisture scavenger absorbs the moistures from the environment before it reacts with the NCO containing groups in adhesive, to avoid causing bubble formation problem. An often-used example of moisture scavenger in polyurethane adhesive is molecular sieve. The polyol component A) comprises 0-10 wt %, preferably 0.5-9 wt %, more preferably 1-8 wt %, even more preferably 2-6 wt % of moisture scavenger, preferably, molecular sieve, based on the total weight of the polyol component A).

Catalysts adjust the reaction kinetics to meet the process requirement. Loading more catalyst helps build up initial bonding strength but shorts the pot life. A well-balanced catalyst package is organometallic, including Zn, Bi, and Sn-containing catalysts. The polyol component A) comprises 0-3 wt %, preferably 0.2-2.5 wt %, more preferably 0.5-2 wt %, even more preferably 1-1.5wt % of catalysts, based on the total weight of the polyol component A).

Flame retardants, such as isopropylated phosphate phenol, improve the fire resistance while battery cell is exposed to electricity short. The polyol component A) comprises 0-20 wt %, preferably 0.5-15 wt %, more preferably 1-10 wt %, even more preferably 2-8 wt %, or 3-6 wt % of flame retardants, based on the total weight of the polyol component A).

Rheology modifiers are often included in the either the polyol component A) or the isocyanate component B) or both of the adhesive composition to provide the thixotropic properties for different application needs. The polyol component A) comprises 0-10 wt %, preferably 0.5-9 wt %, more preferably 1-8 wt %, even more preferably 2-6 wt % wt % of rheology modifiers, based on the total weight of the polyol component A).

Conventional adhesion promoters, such as epoxy silanes or polyphosphoric acids, can also be used. The polyol component A) comprises 0-10 wt %, preferably 0.5-9 wt %, more preferably 1-8 wt %, even more preferably 2-6 wt % wt % of conventional adhesion promoters, based on the total weight of the polyol component A). For example, the polyol component A) may comprise 0.05-5.0 wt %, preferably 0.08-3.0 wt %, more preferably 0.09-2.5 wt %, even more preferably 0.1-1.0 wt % or 0.1-0.8 wt % of the polyphosphoric acid, based on the total weight of the polyol component A). Fillers can be added to either the polyol component A) or the isocyanate component B) or both of the adhesive composition to improve the mechanical strength and lower the cost. Fillers can be selected from silica, CaCO₃, Kaolin, Talc, Al₂O₃, boron nitride or aluminum hydroxide etc. The polyol component A) comprises 0-95 wt %, preferably 5-90 wt %, more preferably 10-80 wt %, even more preferably 40-70 wt %, or 50-60 wt % of fillers, based on the total weight of the polyol component A).

### B. Isocyanate Component

The two-component adhesive composition comprises the reaction product of A) a polyol component and B) an isocyanate component. The isocyanate component B) comprises a polyphosphoric acid and the reaction product of (I) an isocyanate compound and (II) a dimer acid polyester polyol, which is an NCO-terminated prepolymer.

An isocyanate prepolymer is an intermediate between monomers and a final polymer.

### Isocyanate Compound

The isocyanate component B) comprises the reaction product of (i) an isocyanate compound and (ii) a dimer acid polyester polyol.

An “isocyanate compound” is a molecule that contains at least two isocyanate groups. The isocyanate compound may chemically bind to a polyol to form a prepolymer. Nonlimiting examples of suitable isocyanate compounds include aromatic isocyanates, aliphatic isocyanates, carbodiimide modified isocyanate compounds, and the combinations thereof. Carbodiimide modified isocyanate compounds are preferred for use in this disclosure. An “aromatic isocyanate compound” is an isocyanate compound containing one or more aromatic rings. Nonlimiting examples of suitable aromatic isocyanate compounds include isomers of methylene diphenyl diisocyanate (MDI) such as 4, 4-MDI, 2, 4-MDI and 2, 2′-MDI; or modified MDI such as carbodiimide modified MDI or allophanate modified MDI; isomers of toluene-diisocyanate (TDI) such as 2, 4-TDI, 2, 6-TDI; isomers of naphthalene-diisocyanate (NDI) such as 1, 5-NDI; and combinations thereof.

An “aliphatic isocyanate compound” is an isocyanate compound that the isocyanate moiety (—NCO) is not directly connected to aromatic rings. Nonlimiting examples of suitable aliphatic isocyanate compounds include isomers of hexamethylene diisocyanate (HDI), isomers of isophorone diisocyanate (IPDI), isomers of xylene diisocyanate (XDI), other cycloaliphatic isocyanates such as methylene bis-cyclohexyl isocyanate (hydrogenated MDI or HMDI) and cyclohexane diisocyanate, and combinations thereof.

In an embodiment, the isocyanate compound is selected from a mono-isocyanate compound, a di-isocyanate compound, a tri-isocyanate compound, and combinations thereof. In a further embodiment, the isocyanate compound is a di-isocyanate compound.

In an embodiment, the isocyanate compound is a multifunctional isocyanate compound with at least two isocyanate groups, or at least three isocyanate groups.

In an embodiment, the isocyanate compound is selected from MDI, TDI, HDI, and combinations thereof. In a further embodiment, the isocyanate compound is MDI.

In an embodiment, the isocyanate compound is selected from carbodiimide modified MDI, carbodiimide modified TDI, carbodiimide modified HDI, and combinations thereof. In a further embodiment, the isocyanate compound is carbodiimide modified MDI.

In an embodiment, the isocyanate compound has a NCO content of no less than 20%, preferably no less than 25%, preferably no less than 28%.

### Dimer Acid Polyester Polyol

The isocyanate component B) comprises the reaction product of (i) the isocyanate compound and (ii) a dimer acid polyester polyol. A “dimer acid polyester polyol” (or “DAPP” or a dimer acid based polyester polyol) is a polyester polyol containing units derived from dimer acid. In an embodiment, the DAPP is the reaction product of (i) a dimer acid, (ii) at least one polyol, and (iii) optionally, other carbonyl-containing compounds, such as a dicarboxylic acid, an anhydride, or a caprolactone.

i. Dimer Acid

In an embodiment, the DAPP is the reaction product of a reaction mixture including (i) a dimer acid, (ii) at least one polyol, and (iii) optionally, other carbonyl-containing compounds, such as a dicarboxylic acid, an anhydride, or a caprolactone.

A “dimer acid” is a dicarboxylic acid compound obtained by allowing a fatty acid having from two to four ethylenic double bonds and from 14 to 22 carbon atoms (hereinafter referred to as “Unsaturated Fatty Acid A”), and a fatty acid having from one to four ethylenic double bonds and from 14 to 22 carbon atoms (hereinafter referred to as an “Unsaturated Fatty Acid B”), to react on double bonds in a dimerization reaction. In an embodiment, Unsaturated Fatty Acid A has two ethylenic double bonds and from 14 to 22 carbon atoms, and the Unsaturated Fatty Acid B has one or two ethylenic double bonds and from 14 to 22 carbon atoms. Nonlimiting examples of suitable Unsaturated Fatty Acid A include tetradecadienoic acids, hexadecadienoic acids, octadecadienoic acids (such as linoleic acid), eicosadienoic acids, docosadienoic acids, octadecatrienoic acids (such as linolenic acid), eicosatetraenoic acids (such as arachidonic acid), and combinations thereof. Nonlimiting examples of suitable Unsaturated Fatty Acid B include the above examples, as well as tetradecenoic acids (tsuzuic acid, physeteric acid, myristoleic acid), hexadecenoic acids (such as palmitoleic acid), octadecenoic acids (such as oleic acid, elaidic acid, and vaccenic acid), eicosenoic acids (such as gadoleic acid), and docosenoic acids (such as erucic acid, setoleic acid, and brassidic acid), and combinations thereof.

The obtained dimer acid is a mixture of dimer acids the structures of which differ according to the binding site or isomerization of a double bond. A non-limiting example of a suitable dimer acid structure is the following Structure (A), Structure (B), Structure (C), Structure (D), or Structure (E):

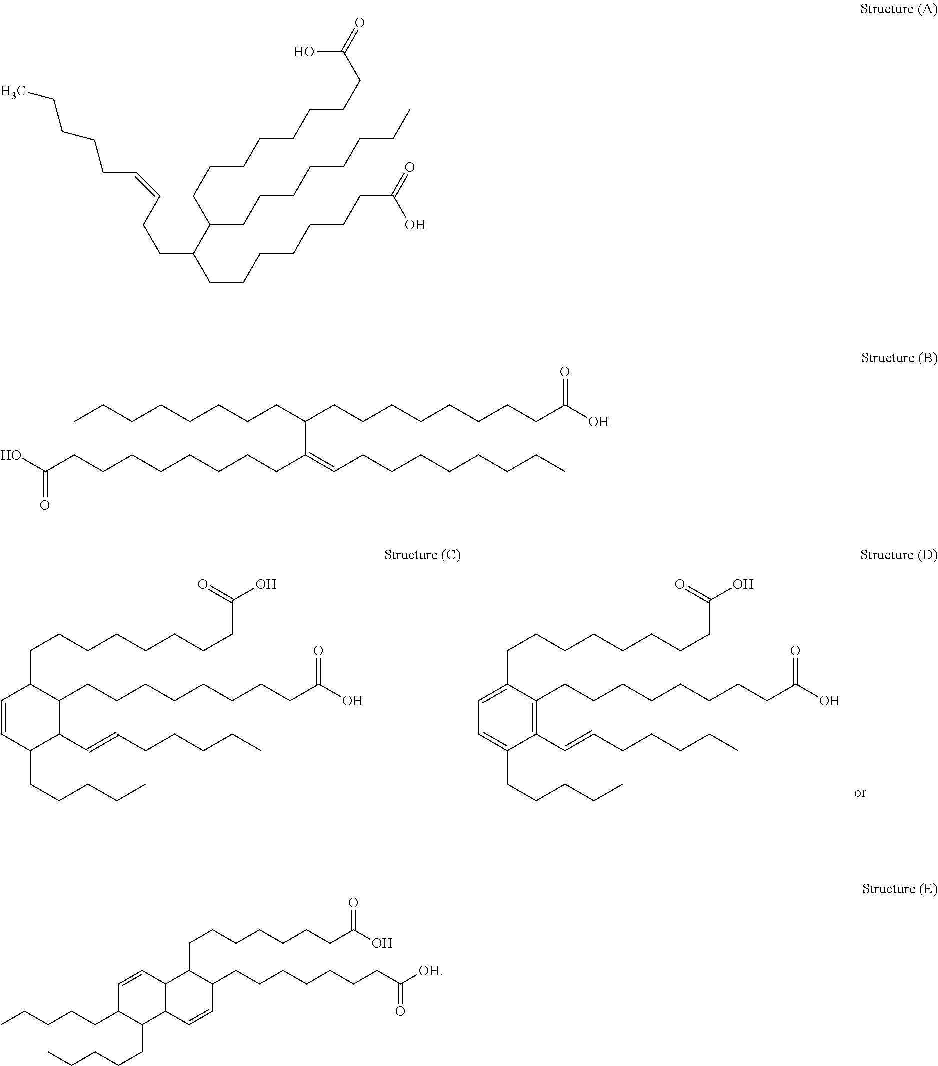 [SMILES: CCCCC/C=C\CCC(CCCCCCCC(=O)O)C(CCCCCCCC)CCCCCCCCC(=O)O ; CCCCCCCC/C=C(/CCCCCCCCC(=O)O)C(CCCCCCCC)CCCCCCCCC(=O)O ; CCCCC/C=C/C1C(CCCCC)C=CC(CCCCCCCCC(=O)O)C1CCCCCCCCC(=O)O ; CCCCC/C=C/c1c(CCCCC)ccc(CCCCCCCCC(=O)O)c1CCCCCCCCC(=O)O ; CCCCCC1C=CC2C(C=CC(CCCCCCCC(=O)O)C2CCCCCCCC(=O)O)C1CCCCC]

In an embodiment, the dimer acid is a C36 dimer acid. In a further embodiment, the C36 dimer acid has the Structure (A).

In an embodiment, the obtained dimer acid includes from 0 wt % to 2 wt %, or 4 wt %, or 6 wt % monomer acid and/or from 0 wt % to 2 wt %, or 4 wt %, or 6 wt % polymer acid having a degree of polymerization greater than, or equal to, the degree of polymerization of a trimer acid.

In an embodiment, the dimer acid is unsaturated. An “unsaturated dimer acid” includes at least one carbon-carbon double bond. Structure (A) is an unsaturated dimer acid. A nonlimiting example of a suitable dimer acid is ATUREX™ 1001 (CAS 61788-89-4), available from Jiangxi Aturex Co., Ltd.

In an embodiment, the dimer acid has an acid value from 150 mg KOH/g, or 160 mg KOH/g, or 170 mg KOH/g, or 180 mg KOH/g, or 190 mg KOH/g, or 194 mg KOH/g to 200 mg KOH/g, or 210 mg KOH/g, or 220 mg KOH/g, or 230 mg KOH/g, or 240 mg KOH/g, or 250 mg KOH/g. In another embodiment, the dimer acid has an acid value from 150 mg KOH/g to 250 mg KOH/g, or from 180 mg KOH/g to 220 mg KOH/g, or from 190 mg KOH/g to 200 mg KOH/g.

In an embodiment, the dimer acid has the Structure (A) and has an acid value from 150 mg KOH/g to 250 mg KOH/g, or from 180 mg KOH/g to 220 mg KOH/g, or from 190 mg KOH/g to 200 mg KOH/g. In a further embodiment, the dimer acid is ATUREX™ 1001 (CAS 61788-89-4), available from Jiangxi Aturex Co., Ltd.

The dimer acid may comprise two or more embodiments disclosed herein.

ii. Polyol

In an embodiment, the DAPP is the reaction product of a reaction mixture including (i) a dimer acid, (ii) at least one polyol, and (iii) optionally, other carbonyl-containing compounds, such as a dicarboxylic acid, an anhydride, or a caprolactone.

Nonlimiting examples suitable polyols include diols (which contain two hydroxyl groups), triols (which contain three hydroxyl groups), and combinations thereof. In an embodiment, the polyol includes a diol and a triol.

Nonlimiting examples of suitable diols include 3-methyl 1,5-pentane diol (MPD); 2-methyl-1, 3-propanediol (MPG); ethylene glycol; butylene glycol; diethylene glycol (DEG); triethylene glycol; polyalkylene glycols, such as polyethylene glycol and polypropylene glycol; 1, 2-propanediol; 1, 3-propanediol; 1, 3-butanediol; 1, 4-butanediol; 1, 6-hexanediol; and neopentyl glycol (NPG).

A nonlimiting example of a suitable triol is trimethylolpropane (TMP).

In an embodiment, the polyol is a diol. In a further embodiment, the diol is MPD.

The polyol may comprise two or more embodiments disclosed herein.

iii. Optional Carbonyl-Containing Compounds, such as Dicarboxylic Acid, Anhydrides, or Caprolactones.

In an embodiment, the DAPP is the reaction product of a reaction mixture including (i) a dimer acid, (ii) at least one polyol, and (iii) optionally, other carbonyl-containing compounds, such as a dicarboxylic acid, an anhydride, or a caprolactone.

The optional carbonyl-containing compounds can be for example, dicarboxylic acid, anhydrides, or caprolactones. The (iii) dicarboxylic acid is not a dimer acid. In other words, the (iii) dicarboxylic acid is structurally distinct and/or compositionally distinct from the (i) dimer acid in the reaction mixture.

Nonlimiting examples of suitable dicarboxylic acids include aliphatic acids, aromatic acids, and combinations thereof. Nonlimiting examples of suitable aromatic dicarboxylic acids include phthalic acid, isophthalic acid, and terephthalic acid. Nonlimiting examples of suitable of suitable aliphatic dicarboxylic acids include cyclohexane dicarboxylic acid, adipic acid, azelaic acid, sebacic acid, glutaric acid, maleic acid, fumaric acid, itaconic acid, malonic acid, suberic acid, 2-methyl succinic acid, 3, 3-diethyl glutaric acid, 2, 2-dimethyl succinic acid, and trimellitic acid. As used herein, the term “acid” also includes any anhydrides of said acid. Saturated aliphatic and/or aromatic acids are also suitable, such as adipic acid or isophthalic acid.

In an embodiment, the dicarboxylic acid has from four, or five, or six to seven, or eight, or nine, or ten carbon atoms. In another embodiment, the dicarboxylic acid has from four to ten carbon atoms, or from six to eight carbon atoms. In a further embodiment, the dicarboxylic acid has eight carbon atoms.

In an embodiment, the dicarboxylic acid is selected from phthalic acid, isophthalic acid, terephthalic acid, and combinations thereof.

The dicarboxylic acid may comprise two or more embodiments disclosed herein.

iv. Optional Additive

In an embodiment, the DAPP is the reaction product of a reaction mixture including (i) a dimer acid, (ii) at least one polyol, (iii) optionally, other carbonyl-containing compounds, such as a dicarboxylic acid, an anhydride, or a caprolactone, and (iv) optionally, an additive.

Nonlimiting examples of suitable optional additives include adhesion promoters, chain extenders, catalysts, and combinations thereof.

A nonlimiting example of a suitable adhesion promoter is amino silane.

Nonlimiting examples of suitable chain extenders include glycerin; trimethylolpropane; diethylene glycol; propanediol; 2-methyl-1, 3-propanediol; and combinations thereof.

Nonlimiting examples of suitable catalysts include tetra-n-butyl titanate, zinc sulphate, organic tin catalyst, and combinations thereof.

In an embodiment, the reaction mixture excludes a chain extender.

The optional additive may comprise two or more embodiments disclosed herein.

The isocyanate component B) may comprise 5-99.95 wt %, preferably 10-95 wt %, more preferably 20-90 wt %, even more preferably 25-80 wt % or 30-60 wt % or 35-50 wt % of the reaction product of (i) an isocyanate compound and (ii) a dimer acid polyester polyol, based on the total weight of the isocyanate component B).

The isocyanate component B) also comprises a polyphosphoric acid. Polyphosphoric acid has a formula of HO[P(OH)(O)O]ₙH, wherein n represents the polymerization degree of the repeat unit.

The isocyanate component B) comprises 0.05-5.0 wt %, preferably 0.08-3.0 wt %, more preferably 0.09-2.5 wt %, even more preferably 0.1-1.0 wt % or 0.1-0.8 wt % of the polyphosphoric acid, based on the total weight of the isocyanate component B).

The isocyanate component B) can optionally include plasticizers, flame retardants, adhesion promoters, rheology modifiers, fillers or the like.

Plasticizers, such as diisononyl phthalate, help reduce the skinning accumulated during the application of isocyanate component B). The isocyanate component B) comprises 0-20 wt %, preferably 0.1-15 wt %, more preferably 0.2-10 wt %, even more preferably 0.3-8 wt %, or 0.5-6 wt % of plasticizers, based on the total weight of the isocyanate component B).

Flame retardants, such as isopropylated phosphate phenol, improve the fire resistance while battery cell is exposed to electricity short. The isocyanate component B) comprises 0-20 wt %, preferably 0.1-15 wt %, more preferably 0.2-10 wt %, even more preferably 0.3-8 wt %, or 0.5-6 wt % of flame retardants, based on the total weight of the isocyanate component B).

Other conventional adhesion promoters, such as epoxy silanes, can also be used. The isocyanate component B) comprises 0-10 wt %, preferably 0.5-9 wt %, more preferably 0.6-8 wt %, even more preferably 0.8-6 wt % wt % of other conventional adhesion promoters, based on the total weight of the isocyanate component B).

Rheology modifiers, such as fumed silica, are often included in the adhesive composition to provide the thixotropic properties for different application needs. In isocyanate component B), fume silica with hydrophobic surface treatment is often used as a rheology modifier. The isocyanate component B) comprises 0-10 wt %, preferably 0.5-9 wt %, more preferably 0.6-8 wt %, even more preferably 0.8-6 wt % wt % of rheology modifiers, based on the total weight of the isocyanate component B).

Fillers are added in the adhesive composition to improve the mechanical strength and lower the cost. Fillers can be selected from silica, CaCO_{3,} Kaolin, Talc, Al₂O₃, boron nitride or aluminum hydroxide etc. The isocyanate component B) comprises 0-95 wt %, preferably 5-90 wt %, more preferably 10-80 wt %, even more preferably 40-70 wt % of fillers, based on the total weight of the isocyanate component B).

The mixture for preparing the reaction product of (i) an isocyanate compound and (ii) a dimer acid polyester polyol (also called the NCO-terminated prepolymer) typically comprises 60-95 wt %, preferably 65-85 wt %, more preferably 70-80 wt %, of aromatic isocyanates and 5-40 wt %, preferably 15-35 wt %, more preferably 20-30 wt %, of dimer acid polyester polyol, based on the total weight of the mixture for preparing the reaction product of (i) an isocyanate compound and (ii) a dimer acid polyester polyol.

The isocyanate component B) typically comprises 30-100wt %, preferably 35-95 wt %, more preferably 38-90 wt %, even more preferably 40-80 wt % or 50-75 wt % or 60-70 wt % of the reaction product of (i) an isocyanate compound and (ii) a dimer acid polyester polyol, and optionally 0-20 wt %, preferably 0.1-15 wt %, more preferably 0.2-10 wt %, even more preferably 0.3-8 wt %, or 0.5-6 wt % of plasticizers, 0-20 wt %, preferably 0.1-15 wt %, more preferably 0.2-10 wt %, even more preferably 0.3-8 wt %, or 0.5-6 wt % of flame retardants, 0-10 wt %, preferably 0.5-9 wt %, more preferably 0.6-8 wt %, even more preferably 0.8-6 wt % wt % of other conventional adhesion promoters, 0-10 wt %, preferably 0.5-9 wt %, more preferably 0.6-8 wt %, even more preferably 0.8-6 wt % wt % of rheology modifiers and 0-95 wt %, preferably 5-90 wt %, more preferably 10-80 wt %, even more preferably 40-70 wt % of fillers, based on the total weight of the isocyanate component B).

### C. Two-Component Adhesive Composition

The two-component adhesive composition is free of, or substantially free of, a solvent.

In an embodiment, the two-component adhesive composition contains an optional conventional additive. The optional additive may be any optional additive disclosed herein, such as plasticizers, chain extenders, flame retardants, adhesion promoters, rheology modifiers, fillers, moisture scavengers, catalysts and the like.

The two-component adhesive composition is formed by mixing the polyol component A) and the isocyanate component B) under conditions suitable to react the —NCO groups of the isocyanate component with the hydroxyl groups of the polyol component. In an embodiment, the polyol component A) and the isocyanate component B) are combined and mixed via static mixing equipment or dynamic mixing equipment (such as a meter-mix-dispenser) at a temperature from 15° C., or 20° C., or 25° C., or 30° C., or 35° C., or 40° C. to 45° C., or 50° C., or 55° C.

The Isocyanate Index or (“NCO Index”) is the molar ratio of isocyanate groups in the isocyanate component to the amount of hydroxyl groups in the polyol component. The NCO Index is calculated in accordance with the following Equation (1):

$$NCO Index = \frac{( I s o cyanate Component NCO wt \% / 42 ) \times mix ratio}{( Hydroxyl Value of Polyol Component / 56106 )} . \qquad Equation ( 1 )$$

In an embodiment, the two-component adhesive composition has an NCO Index of from 1.05, or 1.10, or 1.15 to 1.85, or 1.80, or 1.70, or 1.60, or 1.50, or 1.40, or 1.30, or 1.25. In another embodiment, the two-component adhesive composition has an NCO Index of from 1.05 to 1.85, or from 1.05 to 1.80, or from 1.10 to 1.60, or from 1.15 to 1.25.

In an embodiment, the two-component adhesive composition includes the polyol component A) and the isocyanate component B) at an Isocyanate Component B): Polyol Component A) volume ratio from 120:100 to 80:100, or from 115:100 to 90:100, or from 110:100 to 95:100, or from 105:100 to 98:100.

The two-component adhesive composition may comprise two or more embodiments disclosed herein.

### D. Multi-Layer Structure

The present disclosure provides a multi-layer structure. The multi-layer structure includes a first substrate, a second substrate, and an adhesive layer between the first substrate and the second substrate. The adhesive layer is formed from the two-component adhesive composition.

The two-component adhesive composition may be any two-component adhesive composition disclosed herein.

### First Substrate and Second Substrate

The multi-layer structure includes a first substrate and a second substrate.

The first substrate and the second substrate may be the same or different. In an embodiment, the first substrate and the second substrate are the same, such that they have the identical compositions and identical structures.

In an embodiment, the first substrate and the second substrate are compositionally distinct and/or structurally distinct from one another.

It is understood that the below description referring to a “substrate” refers to the first substrate and the second substrate, individually and/or collectively.

A nonlimiting example of a suitable substrate is a film. The film may be a monolayer film or a multilayer film. The multilayer film contains two layers, or more than two layers. For example, the multilayer film can have two, three, four, five, six, seven, eight, nine, ten, eleven, or more layers. In an embodiment, the multilayer film contains only two layers, or only three layers.

In an embodiment, the film is a monolayer film with one, and only one, layer.

In an embodiment, the film includes a layer containing a component selected from ethylene-based polymer (PE), propylene-based polymer (PP), polyamide (such as nylon), polyester, ethylene vinyl alcohol (EVOH) copolymer, polyethylene terephthalate (PET), ethylene vinyl acrylate (EVA) copolymer, ethylene methyl acrylate copolymer, ethylene ethyl acrylate copolymer, ethylene butyl acrylate copolymer, ethylene acrylic acid copolymer, ethylene methacrylic acid copolymer, an ionomer of ethylene acrylic acid, an ionomer of methacrylic acid, maleic anhydride grafted ethylene-based polymer, a polylactic acid (PLA), a polystyrene, a metal foil, a cellulose, cellophane, nonwoven fabric, and combinations thereof. A nonlimiting example of a suitable metal foil is aluminum foil. Each layer of a multilayer film may for formed from the same component, or from different components.

In an embodiment, the film includes a layer containing metal foil.

In an embodiment, the film is a monolayer film having a single layer that is an ethylene-based polymer layer. In a further embodiment, the film is a monolayer film having a single layer that is a polyethylene layer.

The substrate, and further the film, is a continuous structure with two opposing surfaces.

In an embodiment, the substrate has a thickness from 5 μm, or 10 μm, or 12 μm, or 15 μm, or 20 μm, or 21 μm to 23 μm, or 24 μm, or 25 μm, or 30 μm, or 35 μm, or 40 μm, or 45 μm, or 50 μm, or 100 μm, or 150 μm, or 200 μm, or 250 μm, or 300 μm, or 350 μm, or 400 μm, or 450 μm, or 500 μm.

In an embodiment, the substrate excludes cellulose-based substrates, such as paper and wood.

In an embodiment, the first substrate is a monolayer film having a single layer that is a PE layer; and the second substrate is a film having a layer that is a metal foil layer.

The film may comprise two or more embodiments disclosed herein.

The first substrate may comprise two or more embodiments disclosed herein. The second substrate may comprise two or more embodiments disclosed herein.

The two-component adhesive composition is applied between the first substrate and the second substrate, such as with a Nordmeccanica Labo Combi 400 laminator. In an embodiment, the two-component adhesive composition is applied between the first substrate and the second substrate at a temperature from 20° C., or 30° C., or 40° C. to 50° C., or 60° C., or 70° C., or 80° C., or 90° C.

Nonlimiting examples of suitable application methods include brushing, pouring, spraying, coating, rolling, spreading, and injecting.

In an embodiment, the two-component adhesive composition is applied between the first substrate and the second substrate by conventional coating methods.

In an embodiment, the two-component adhesive composition is uniformly applied between the first substrate and the second substrate. A “uniform application” is a layer of the composition that is continuous (not intermittent) across a surface of the substrate, and of the same, or substantially the same, thickness across the surface of the substrate. In other words, a composition that is uniformly applied to a substrate directly contacts the substrate surface, and the composition is coextensive with the substrate surface.

The two-component adhesive composition and the first substrate are in direct contact with each other. The term “directly contact,” as used herein, is a layer configuration whereby a substrate is located immediately adjacent to a two-component adhesive composition, or an adhesive layer and no intervening layers, or no intervening structures, are present between the substrate and the two-component adhesive composition, or an adhesive layer. The two-component adhesive composition directly contacts a surface of the first substrate.

The two-component adhesive composition and the second substrate are in direct contact with each other. The two-component adhesive composition directly contacts a surface of the second substrate.

The structure containing the first substrate, the second substrate, and the two-component adhesive composition has the following Structure (P):

First Substrate/Two-Component Adhesive Composition/Second Substrate Structure (P).

The adhesive layer of Structure (P) is formed from curing the two-component adhesive composition. The two-component adhesive composition is formed from mixing and reacting the polyol component A) and isocyanate component B).

In an embodiment, the two-component adhesive composition is cured in an oven at a temperature from 10° C., 20° C., or 35° C. to 40° C., or 45° C., or 50° C.

In an embodiment, the two-component adhesive composition is cured at a temperature from 20° C. to 30° C., preferably 25° C., for a period of from 1 day to 2 days, or 4 days, or 7 days or 10 days.

In an embodiment, the two-component adhesive composition is cured in the absence, or in the substantial absence, of a photo-initiator.

In an embodiment, the two-component adhesive composition is cured in the absence, or in the substantial absence, of water.

In an embodiment, the Structure (P) is cured to form an adhesive layer between the first substrate and the second substrate, thereby forming a multi-layer structure. The multi-layer structure has the following Structure (Q):

First Substrate/Adhesive Layer/Second Substrate Structure (Q).

The multi-layer structure includes the first substrate in direct contact with the adhesive layer, and the second substrate in direct contact with the adhesive layer.

The multi-layer structure includes alternating substrate layers and adhesive layers. The multi-layer structure includes at least three total layers, total layers including the substrate layers and the adhesive layers. In an embodiment, the multi-layer structure includes from three to four, or five, or six, or seven, or eight, or nine, or ten total layers.

In an embodiment, the first substrate is a monolayer film having a single layer that is a metal foil layer and the second substrate is a monolayer film having a single layer that is a metal foil layer, and the multi-layer structure has a lap shear strength of from 7 MPa, or 7.5 MPa, or 8 MPa or 8.5 MPa to 15 MPa, or 13 MPa, or 12 MPa, and/or has a cross tensile strength of from 12.5 MPa, or 13.0 MPa, or 13.5 MPa, or 14 MPa to 30 MPa, or 25 MPa, or 22 MPa.

### E. Method of Forming a Two-Component Solvent-Less Adhesive Composition

The present disclosure also provides a method of forming a two-component adhesive composition comprising:
i) providing a polyol component A), comprising at least one hydrophobic polyol;
ii) providing an isocyanate component B), comprising the reaction product of (I) an isocyanate compound and (II) a dimer acid polyester polyol; and polyphosphoric acid; and
iii) reacting the isocyanate component B) with the polyol component A) to form the two-component adhesive composition.

The multi-layer structure can be in the form of a jelly roll or a laminate, preferably in a battery package.

The present disclosure also provides an article containing the multi-layer structure. Nonlimiting examples of suitable articles include packages, such as battery packages.

By way of example, and not limitation, some embodiments of the present disclosure will now be described in detail in the following Examples.

### EXAMPLES

The materials used in the examples are provided in Table 1 below.

TABLE 1
Raw materials used in the examples

| Category | Chemical Name | Specification | Supplier |
|---|---|---|---|
| Polyol | Castor Oil | OH value 163, | Guangzhou |
| | | density 0.961 g/cm³, | Hanhao |
| | | functionality 2.7 | Chemical |
| | | | Co., Ltd. |
| Polyol | VORANOL CP | Polyether polyol, | Dow |
| | 450 | OH value 373, | |
| | | density 1.01 g/cm³, | |
| | | functionality 3 | |
| Polyol | VORANOL P 400 | Polyether polyol, | Dow |
| | | OH value 260, | |
| | | density 1.01 g/cm³, | |
| | | functionality 2 | |
| Polyol | Poly- (tetra | OH value 56.5, | BASF |
| | Methylene Ether | density 1.01 g/cm³, | |
| | Glycol) with Mw. | functionality 2 | |
| | 2000 g/mol | | |
| | (PTMEG2000) | | |
| Chain | 1,4-BDO | Molecular weight | BASF |
| Extender | | 90, density 1.01 | |
| | | g/cm³, functionality | |
| | | 2 | |
| Dimeric Acid | ATUREX-1001 | Acid value 194-200, | Jiangxi |
| | | dibasic acid >98%, | Aturex Co., |
| | | | Ltd. |
| Diol | 2-Methyl-1,3- | Molecular weight 90 | Merck |
| | Propane diol | | |
| Diol | 1,6-Hexanediol | Molecular weight | Merck |
| | | 118 | |
| Catalyst | Tyzor TBT | density 1.00 g/cm³, | Merck |
| | | CAS No. 5593-70-4 | |
| Isocyanate | ISONATE 143L | Carbodiimide | Dow |
| | | modified MDI, NCO | |
| | | content 29%, | |
| | | functionality 2 | |
| Isocyanate | ISONATE OP 50 | NCO content 33.5%, | Dow |
| | | functionality 2 | |
| Isocyanate | PAPI 27 | NCO content 31.2%, | Dow |
| | Polymeric MDI | functionality 2.7 | |
| Acid/Adhesion | Polyphosphoric | HO[P(OH)(O)O]ₙH, | Merck |
| Promoter | Acid | CAS No. 8017-16-1 | |
| Acid | Phosphoric Acid | Density 1.88 g/cm³, | Merck |
| | | CAS No. 7664-38-2 | |
| Phosphate | Triethlyl | Density 1.07 g/cm³, | Merck |
| | Phosphate (TEP) | CAS No. 78-40-0 | |
| Phosphate | Tris(chloropropyl) | Density 1.48 g/cm³, | Merck |
| | phosphate (TCPP) | CAS No. 13674-87- | |
| | | 8 | |
| Adhesion | 3- | Density 1.07 g/cm³ | Dow |
| Promoter | Glycidoxypropyl | | |
| | Trimethoxysilane, | | |
| | Z-6040 | | |
| Flame | IPPP | Density 1.17 g/cm³ | Suzhou |
| Retardant | (Isopropylated | | Eastop |
| | Phosphate | | Chemical |
| | Phenol) | | Co., Ltd. |
| Plasticizer | DINP (Diisononyl | Density 0.975 g/cm³ | Merck |
| | Phalate) | | |
| Moisture | Molecular Sieve | Density 2.1 g/cm³ | GRACE |
| Scavenger | 3A | | |
| Rheology | Fume silica, | Hydrophobically | Evonik |
| Modifier | AEROSIL R 974 | modified, density 2.1 | |
| | | g/cm³ | |
| Rheology | Fume silica, H-18 | Hydrophobically | Evonik |
| Modifier | | modified, density 2.1 | |
| | | g/cm³ | |
| Filler | Aluminum | Density 2.4 g/cm³ | Shandong |
| | Hydroxide (ATH), | | Shibang |
| | 18 μm | | Co., Ltd. |
| Filler | Alumina (Al₂O₃), | Density 3.5 g/cm³ | Shanghai |
| | 40 μm | | Bestry |
| | | | Performance |
| | | | Materials |
| | | | Co., Ltd. |
| Filler | Boron Nitride | Density 2.25 g/cm³ | Saint- |
| | | | Gobain |

### Synthesis of Dimeric Acid Based Polyester Polyol-1:

100 g 1,6-Hexanediol, 353 g ATUREX-1001 were charged into a 500 ml glass reactor and mixed completely. The mixture was heated to 100° C. When the raw materials turned to a liquid, then agitation was started. The temperature was controlled on the proper position and monitored in the whole process. If the top temperature of glass condenser increased above 103° C., the reactor was cooled as soon as possible. When the reaction temperature increased to 220° C., top temperature fell below 100° C., vacuum was started slowly in 30 minutes to 30 mm Hg. The acid value was checked every 30 minutes. A certain amount of catalyst Tyzor TBT was added until acid value was less than 10. The catalyst was added and the reaction system was maintained at 30 mm Hg vacuum condition for more than 1 hour until the OH value of the reaction system reached theoretical value. The mixture was cooled down to 60-70° C., and the final product was collected as dimer acid based polyester diol-1.

### Synthesis of Dimeric Acid Based Polyester Polyol-2:

100 g 2-mehtyl-1,3-propane diol, 467.5 g ATUREX-1001 were charged into a 500 ml glass reactor and mixed completely. The mixture was heated to 100° C. When the raw materials turned to a liquid, then agitation was started. The temperature was controlled on the proper position and monitored in the whole process. If the top temperature of glass condenser increased above 103° C., the reactor was cooled as soon as possible. When the reaction temperature increased to 220° C., top temperature fell below 100° C., vacuum was started slowly in 30 minutes to 30 mm Hg. The acid value was checked every 30 minutes. A certain amount of catalyst Tyzor TBT was added until acid value was less than 10. The catalyst was added and the reaction system was maintained at 30 mm Hg vacuum condition for more than 1 hour until the OH value of the reaction system reached theoretical value. The mixture was cooled down to 60-70° C., and the final product was collected as dimer acid based polyester diol-2.

### Synthesis of Polyurethane Polyol (OH-Terminated Polyurethane Prepolymer, i.e. a Castor Oil Derivative):

The polyurethane polyol was synthesized in a 1,000 ml glass reactor as normal polyurethane pre-polymer preparation process. 12 g ISONATE OP 50 was charged into the reactor and kept at 60° C. under nitrogen protection, then 44 g castor oil and 44 g VORANOL P 400 were charged into the reactor to mix with ISONATE OP 50. The temperature was increased to 80° C. slowly and held for 2 hours. The polyurethane polyol was finally charged into a well-sealed container with nitrogen protection for further use.

### Synthesis of NCO-Terminated Prepolymer-1:

75 g ISONATE 143L was charged into a 1,000ml glass reactor and kept at 60° C. under nitrogen protection, then 25 g PTMEG2000 was charged into the reactor to mix with ISONATE 143L. The temperature was increased to 80° C. slowly and held for 2-3 hour until NCO content met the theoretical value. Finally, the pre-polymer was charged into a well-sealed container with nitrogen protection for further application.

### Synthesis of NCO-Terminated Prepolymer-2:

75 g ISONATE 143L was charged into a 1,000ml glass reactor and kept at 60° C. under nitrogen protection, then 25 g dimeric acid based polyester diol-1 was charged into the reactor to mix with ISONATE 143 L. The temperature was increased to 80° C. slowly and held for 2-3 hours until NCO content met the theoretical value. Finally, the pre-polymer was charged into a well-sealed container with nitrogen protection for further application.

### Synthesis of NCO-Terminated Prepolymer-3:

75 g ISONATE 143 L was charged into a 1,000 ml glass reactor and kept at 60° C. under nitrogen protection, then 25 g dimeric acid based polyester diol-2 was charged into the reactor to mix with ISONATE 143 L. The temperature was increased to 80° C. slowly and held for 2-3 hours until NCO content met the theoretical value. Finally, the pre-polymer was charged into a well-sealed container with nitrogen protection for further application.

Part B isocyanate part which can meet moisture-resistance requirements, is summarized in Table 2. Adhesive formulations including Part A and Part B, is summarized in Table 3.

In E01 and E02, very short tacky free time was observed if the isocyanates were used straightly. By comparing E03 with E07 or E10, isocyanates based on prepolymers from dimeric acid polyesters showed much prolonged tacky free time. By comparing E04-E10, only isocyanate parts with the dimeric acid based prepolymers and the addition of phosphoric acid or polyphosphoric acid showed satisfactory tacky free time (≥11 h). This significantly prolonged tacky free time should be attributed to the deactivation effects of the NCO groups by protons.

TABLE 2
Part B Formulations Tested in the present disclosure

| Part B | | E-01 | E-02 | E-03 | E-04 | E-05 | E-06 | E-07 | E-08 | E-09 | E-10 |
|---|---|---|---|---|---|---|---|---|---|---|---|
| Isocyanate | Isonate 143L | 27.04 | | | | | | | | | |
| | PAPI 27 PMDI | | 25.22 | | | | | | | | |
| | Prepolymer-1 | | | 37.84 | | | | | | | |
| | (PTMEG2000) | | | | | | | | | | |
| | Prepolymer-2 | | | | 37.84 | 37.84 | 37.84 | 37.84 | 37.84 | 37.84 | |
| | (Polyester-1) | | | | | | | | | | |
| | Prepolymer-3 | | | | | | | | | | 37.84 |
| | (Polyester-2) | | | | | | | | | | |
| Phosphric Acid | | | | | 0.1 | | | | | | |
| Triethlyl | | | | | | 0.1 | | | | | |
| Phosphate (TEP) | | | | | | | | | | | |
| Tris(chloropropyl) | | | | | | | 0.1 | | | | |
| phosphate (TCPP) | | | | | | | | | | | |
| Polyphosphoric | | 0.1 | 0.1 | 0.1 | | | | 0.1 | 0.2 | 0.4 | 0.1 |
| Acid | | | | | | | | | | | |
| Diisononyl | | 0.54 | 0.54 | 0.54 | 0.54 | 0.54 | 0.54 | 0.54 | 0.54 | 0.54 | 0.54 |
| Phalate (DINP) | | | | | | | | | | | |
| Isopropylated | | 0.54 | 0.54 | 0.54 | 0.54 | 0.54 | 0.54 | 0.54 | 0.54 | 0.54 | 0.54 |
| Phosphate | | | | | | | | | | | |
| Phenol (IPPP) | | | | | | | | | | | |
| Z-6040 | | 0.81 | 0.81 | 0.81 | 0.81 | 0.81 | 0.81 | 0.81 | 0.81 | 0.81 | 0.81 |
| AEROSIL R 974 | | 0.81 | 0.81 | 0.81 | 0.81 | 0.81 | 0.81 | 0.81 | 0.81 | 0.81 | 0.81 |
| Boron Nitride | | 2.70 | 2.70 | 2.70 | 2.70 | 2.70 | 2.70 | 2.70 | 2.70 | 2.70 | 2.70 |
| Alumina (Al₂O₃) | | 56.66 | 56.66 | 56.66 | 56.66 | 56.66 | 56.66 | 56.66 | 56.56 | 56.36 | 56.66 |
| Total | | 89.2 | 87.38 | 100 | 100 | 100 | 100 | 100 | 100 | 100 | 100 |
| Tacky Free Time, h | | 3 | 2 | 5 | 12 | 10 | 10 | 14 | 15 | 15 | 12 |

The adhesive formulations, with details in Part A and the corresponding examples of Part B, were summarized in Table 3. The adhesive application machines are mostly available at 1:1 volume mixing ratio. To ensure adhesive fully cured, the stoichiometric ratio of 2 K polyurethane adhesive is usually set in the range of 1.05-1.85. So, the formulations were designed to meet these requirements. The volume mixing ratio and stoichiometric ratio were calculated and listed in the Table 3.

E01-E03 are comparative examples showing that phosphoric acid (with 15 wt. % water in the product, cannot be removed), triethlyl phosphate (TEP) and tris (chloropropyl) phosphate (TCPP) have limited adhesion promotion effects, while inventive examples 01-05 (Inv. 01-05) with polyphosphoric acid as the adhesion promotors show much improved adhesion strength. By comparing Inv. 01-03 or Inv. 04-05 with increasing amounts of polyphosphoric acid, the adhesion promotion effects were strengthened. By comparing Inv. 01 and Inv.04, different adhesion strengths were achieved by varying the structures of the dimeric acid polyester polyols. Polyphosphoric acid can also be added into the polyol parts to achieve adhesion promotion effects by comparing Inv. 04-05.

TABLE 3
Adhesive Examples

| | Com. | Com. | Com. | Inv. | Inv. | Inv. | Inv. | Inv. |
|---|---|---|---|---|---|---|---|---|
| | 01 | 02 | 03 | 01 | 02 | 03 | 04 | 05 |
| Part A | | | | | | | | |
| Castor Oil | 16.90 | 16.90 | 16.90 | 16.90 | 16.90 | 16.90 | 16.90 | 16.90 |
| Polyurethane Polyol | 11.74 | 11.74 | 11.74 | 11.74 | 11.74 | 11.74 | 11.74 | 11.74 |
| VORANOL CP 450 | 4.23 | 4.23 | 4.23 | 4.23 | 4.23 | 4.23 | 4.23 | 4.23 |
| 1,4-BDO | 2.11 | 2.11 | 2.11 | 2.11 | 2.11 | 2.11 | 2.11 | 2.11 |
| Polyphosphoric acid | | | | | | | | 0.10 |
| Molecular Sieve 3A | 3.99 | 3.99 | 3.99 | 3.99 | 3.99 | 3.99 | 3.99 | 3.99 |
| Fume Silica, H-18 | 1.64 | 1.64 | 1.64 | 1.64 | 1.64 | 1.64 | 1.64 | 1.64 |
| Aluminum Hydroxide (ATH) | 59.39 | 59.39 | 59.39 | 59.39 | 59.39 | 59.39 | 59.39 | 59.29 |
| Total | 100 | 100 | 100 | 100 | 100 | 100 | 100 | 100 |
| Part B | | | | | | | | |
| E04 | 118.0 | | | | | | | |
| E05 | | 118.0 | | | | | | |
| E06 | | | 118.0 | | | | | |
| E07 | | | | 118.0 | | | | |
| E08 | | | | | 118.0 | | | |
| E09 | | | | | | 118.0 | | |
| E10 | | | | | | | 118.0 | 118.0 |
| ISO Index, NCO/OH | 1.19 | 1.19 | 1.19 | 1.19 | 1.19 | 1.19 | 1.19 | 1.19 |
| Volume ratio, B/A | 1.00 | 1.00 | 1.00 | 1.00 | 1.00 | 1.00 | 1.00 | 1.00 |
| Lap-shear Strength, MPa | | | | | | | | |
| Mean from 5 measurements | 6.66 | 8.16 | 7.85 | 13.35 | 14.59 | 13.56 | 8.69 | 10.83 |
| Cross-tensile Strength, | | | | | | | | |
| MPa | | | | | | | | |
| Mean from 5 measurements | 8.96 | 11.76 | 12.10 | 20.50 | 21.12 | 19.70 | 13.90 | 13.82 |

*Com.—Comparative Example; Inv.—Inventive Example. Lap-shear Strength ≥8.5 MPa and Cross-tensile Strength ≥12.5 MPa are preferred

Part B isocyanate prepolymer was prepared following the procedure below:
Step 1 Charge NCO-terminated prepolymer into the vessel; then add other liquid components (DINP, IPPP, Z-6040, etc.)
Step 2 Apply vacuum and mix with a medium stirring rate for 30 min;
Step 3 Charge alumina into the vessel; apply vacuum after powder incorporation; mix with a high stirring rate for 30 min;
Step 4 Charge fumed silica into the vessel; apply vacuum after powder incorporation; mix with a high stirring rate for 1 hour;
Step 5 Set temperature bath to 80° C.; keep mixing with a medium to low stirring rate for 30 min to sustain the temperature;
Step 6 Set temperature bath to 20° C. to cool down to <40° C.

Tacky free time was tested following procedure below:

Take 10 g part B in a 50 ml Plastic beaker, put the beaker in oven under 45% humidity and 23° C. temperature. Start time recording. Periodically take out the beaker and use a plastic stick to touch the surface of part B softly. With the increasing reaction between part B and moisture, the surface viscosity increases. Stop the time recording when surface of part B is not sticky anymore. The duration is recorded as tacky free time of part B.

Part A polyol mixture is prepared following the procedure below:
Step 1 Charge castor oil, polyurethane polyol, CP450, and BDO into the vessel
Step 2 Heat up to 80° C.: apply vacuum and mix with a medium stirring rate for 1 hour to de-gas.
Step 3 Charge ATH into the vessel, apply vacuum after powder incorporation: mix with high stirring rates for 15 min:
Step 4 Charge Molecular Sieve 3A into the vessel: apply vacuum after powder incorporation: mix with a high stirring rate for 15 min;
Step 5 Charge H-18 into the vessel: apply vacuum after powder incorporation: mix with a high stirring rate for 1 hour;
Step 6 Cool down to <40° C.

### Test Methods:

Lap-joint test coupons were made with the procedure below:
1. Substrate was made by 3003 aluminum alloy with a dimension of 25 mm×12.5 mm.
2. Clean the substrate surface by wiping off with ethanol.
3. Mask out 25 mm×12 mm bonding area by using pressure sensitive tape.
4. Mix the Part A and Part B of adhesive and put in speedmixer at 1,000 rpm for 1 min to make sure thoroughly mixing.
5. Apply 0.5 g to 1.5 g adhesive in the bonding area of the substrate. Put two copper wires with diameter 0.2 mm to control the thickness of adhesive.
6. Along the length direction, stack another masked substrate with the same bonding area contacted head-to-head. Press and fasten the bonding surfaces with two clippers side by side.
7. Cure the adhesive at 25° C. for 7 days.

Butt-joint test coupons were made based on procedure below:
1. Substrate was made by 3003 aluminum alloy with a dimension of 60 mm height and 15 mm diameter.
2. Clean the substrate surface by wiping off with ethanol.
3. Mix the Part A and Part B of adhesive and put in speedmixer at 1,000 rpm for 1 min to make sure thoroughly mixing.
4. Apply 0.5 g to 1 g adhesive on the flat surface of substrate. Put two copper wires with diameter 0.25 mm to control the thickness of adhesive.
5. Stack another cleaned substrate with the flat surface bonded together. Keep the stacked substrates vertically so the bonding surfaces can be constantly fastened by gravity force.
6. Cure the adhesive at 25° C. for 7 days.

Test coupons were assembled on the fixture of Instron test machine (Model: Instron 5566) and tested at strain rate of 5 mm/min for shear strength of lap-joints and tensile strength of butt-joints.

1. A two-component adhesive composition comprising the reaction product of:
A) a polyol component, comprising at least one hydrophobic polyol: and
B) an isocyanate component, comprising a polyphosphoric acid and the reaction product of (I) an isocyanate compound and (II) a dimer acid polyester polyol.

2. The two-component adhesive composition of claim 1, wherein the hydrophobic polyol is selected from a vegetable oil, a hydrophobic polyol derived from a vegetable oil, or a mixture thereof.

3. The two-component adhesive composition of claim 1, wherein the dimer acid polyester polyol comprises the reaction product of a reaction mixture comprising:
a) a dimer acid, and
b) at least one polyol.

4. The two-component adhesive composition of claim 1, wherein the dimer acid polyester polyol comprises the reaction product of a reaction mixture comprising:
a) a dimer acid,
b) at least one polyol: and
c) other carbonyl-containing compounds.

5. The two-component adhesive composition of claim 1, wherein the isocyanate component B) comprises 0.05-5.0 wt % of the polyphosphoric acid, based on the total weight of the isocyanate component B).

6. The two-component adhesive composition of claim 1, wherein the polyol component A) comprises 0.05-5.0 wt % of polyphosphoric acid, based on the total weight of the polyol component A).

7. The two-component adhesive composition of claim 1, wherein the two-component adhesive composition has an NCO Index of from 1.05 to 1.85.

8. The two-component adhesive composition of claim 3, wherein the dimer acid has the following Structure (A), Structure (B), Structure (C), Structure (D), or Structure (E):

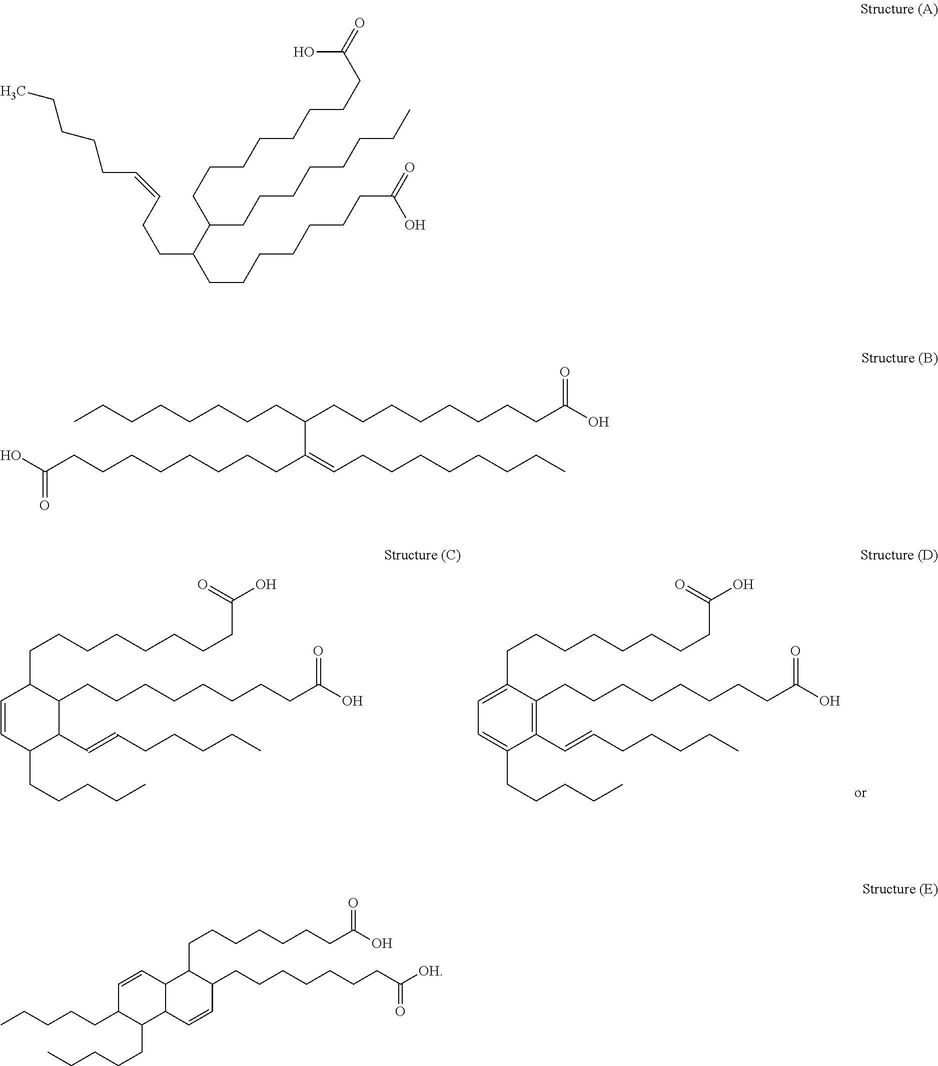 [SMILES: CCCCC/C=C\CCC(CCCCCCCC(=O)O)C(CCCCCCCC)CCCCCCCCC(=O)O ; CCCCCCCC/C=C(/CCCCCCCCC(=O)O)C(CCCCCCCC)CCCCCCCCC(=O)O ; CCCCC/C=C/C1C(CCCCC)C=CC(CCCCCCCCC(=O)O)C1CCCCCCCCC(=O)O ; CCCCC/C=C/c1c(CCCCC)ccc(CCCCCCCCC(=O)O)c1CCCCCCCCC(=O)O ; CCCCCC1C=CC2C(C=CC(CCCCCCCC(=O)O)C2CCCCCCCC(=O)O)C1CCCCC]

9. A multi-layer structure comprising
a first substrate;
a second substrate; and
an adhesive layer between the first substrate and the second substrate, the adhesive layer being formed from the two-component adhesive composition of claim 1.

10. The multi-layer structure of claim 8, wherein the first substrate and the second substrate are, respectively, a film including a layer containing a component selected from ethylene-based polymer (PE), propylene-based polymer (PP), polyamide, polyester, ethylene vinyl alcohol (EVOH) copolymer, polyethylene terephthalate (PET), ethylene vinyl acrylate (EVA) copolymer, ethylene methyl acrylate copolymer, ethylene ethyl acrylate copolymer, ethylene butyl acrylate copolymer, ethylene acrylic acid copolymer, ethylene methacrylic acid copolymer, an ionomer of ethylene acrylic acid, an ionomer of methacrylic acid, maleic anhydride grafted ethylene-based polymer, a polylactic acid (PLA), a polystyrene, a metal foil, a cellulose, cellophane, nonwoven fabric, and combinations thereof.

11. The multi-layer structure of claim 8, wherein the first substrate is a monolayer film having a single layer that is a metal foil layer and the second substrate is a monolayer film having a single layer that is a metal foil layer.

12. A method of forming the two-component adhesive composition of claim 1 comprising:
i) providing a polyol component A), comprising at least one hydrophobic polyol;
i) providing an isocyanate component B), comprising a polyphosphoric acid and the reaction product of (1) an isocyanate compound and (II) a dimer acid polyester polyol; and
iii) then reacting the isocyanate component B) with the polyol component A) to form the two-component adhesive composition.

13. A use of the two-component adhesive composition of claim 1 in a battery pack.
